(19) United States
(12) Patent Application Publication
(10) Pub. No.: US 2025/0284878 A1
(43) Pub. Date: Sep. 11, 2025

(54) INCREMENTAL STREAMING FOR LIVE SUMMARIES

(71) Applicant: GOOGLE LLC, Mountain View, CA (US)

(72) Inventors: Vikas Bahirwani, San Francisco, CA (US); Manish Gupta, Berkeley, CA (US); Alex Olwal, Santa Cruz, CA (US); Christopher Ross, Brooklyn, NY (US); Susan Xu, San Francisco, CA (US)

(21) Appl. No.: 18/862,087

(22) PCT Filed: May 10, 2023
(86) PCT No.: PCT/US2023/021771

§ 371 Date: Oct. 31, 2024

Related U.S. Application Data
(60) Provisional application No. 63/364,478, filed on May 10, 2022.

(51) Int. Cl. G06F 40/166; G06F 40/30; G06F 40/40

(52) U.S. Cl. CPC G06F 40/166; G06F 40/30; G06F 40/40

(57) ABSTRACT

Described techniques may be utilized to process transcribed text of a transcription stream (302) in an incremental fashion. For example, a first summary of first transcribed text may be generated, without requiring knowledge or receipt of second or subsequent transcribed text, and without requiring detection of a detected or manual summarization trigger. Similarly, a second summary of second transcribed text may be generated without requiring knowledge or receipt of third transcribed text. Accordingly, a summary stream (310) of summarized text may be provided in a stable fashion, without overwriting previously generated summaries as new summaries are generated.

### CROSS REFERENCE TO RELATED APPLICATIONS

This application claims the benefit of U.S. Provisional Application No. 63/364,478, filed May 10, 2022, the disclosure of which is incorporated herein by reference in its entirety.

This application also incorporates by reference herein the disclosures to related co-pending applications, U.S. application Ser. No. 18/315,113, filed May 10, 2023, “Multi-Stage Summarization for Customized, Contextual Summaries”, filed May 10, 2023 (Attorney Docket No. 0120-533WO1), “Dynamic Summary Adjustments for Live Summaries”, filed May 10, 2023 (Attorney Docket No. 0120-534WO1), “Summary Generation for Live Summaries with User and Device Customization”, filed May 10, 2023 (Attorney Docket No. 0120-535WO1), “Summarization with User Interface (UI) Stream Control and Actionable Information Extraction”, filed May 10, 2023 (Attorney Docket No. 0120-541WO1), and “Incremental Streaming for Live Summaries”, filed May 10, 2023 (Attorney Docket No. 0120-589WO1).

### TECHNICAL FIELD

This description relates to summarization using machine learning (ML) models.

### BACKGROUND

A volume of text, such as a document or an article, often includes content that is not useful to, or desired by, a consumer of the volume of text. Additionally, or alternatively, a user may not wish to devote time (or may not have sufficient time) to consume an entirety of a volume of text.

Summarization generally refers to techniques for attempting to reduce a volume of text to obtain a reduced text volume that retains most information of the volume of text within a summary. Accordingly, a user may consume information in a more efficient and desirable manner. In order to enable the necessary processing of the text, the latter may be represented by electronic data (text data). For example, a ML model may be trained to input text and output a summary of the text.

### SUMMARY

Described techniques process input text data to reduce a data volume of the input text data and obtain output text data expressing a summary of content of the input text data. The obtained, reduced volume of the output text data may be conformed to a size of a display, so as to optimize a size of the output text data relative to the size of the display. Moreover, described techniques may accomplish such customized data volume reductions with reduced delay, compared to existing techniques and approaches.

In a general aspect, a computer program product is tangibly embodied on a non-transitory computer-readable storage medium and comprises instructions. When executed by at least one computing device, the instructions are configured to cause the at least one computing device to receive first transcribed text of a transcription stream, determine, using an incremental segment generator machine learning (ML) model, a first representation representing the first transcribed text, and determine that the first representation does not satisfy a summarization stability metric. When executed by the at least one computing device, the instructions are configured to cause the at least one computing device to receive second transcribed text of the transcription stream, determine, using the incremental segment generator ML model, a second representation representing the first transcribed text and the second transcribed text, determine that the second representation satisfies the summarization stability metric, and summarize the second representation using a summarizer ML model to obtain a summary of the first transcribed text and the second transcribed text.

According to another general aspect, a device comprises at least one display, at least one processor, and at least one memory storing instructions. When executed by the at least one processor, the instructions cause the device to receive first transcribed text of a transcription stream, determine, using an incremental segment generator machine learning (ML) model, a first representation representing the first transcribed text, and determine that the first representation does not satisfy a summarization stability metric. When executed by the at least one processor, the instructions cause the device to receive second transcribed text of the transcription stream, determine, using the incremental segment generator ML model, a second representation representing the first transcribed text and the second transcribed text, determine that the second representation satisfies the summarization stability metric, and summarize the second representation using a summarizer ML model to obtain a summary of the first transcribed text and the second transcribed text.

According to another general aspect, a method includes receiving first transcribed text of a transcription stream, determining, using an incremental segment generator machine learning (ML) model, a first representation representing the first transcribed text, and determining that the first representation does not satisfy a summarization stability metric. The method further includes receiving second transcribed text of the transcription stream, determining, using the incremental segment generator ML model, a second representation representing the first transcribed text and the second transcribed text, determining that the second representation satisfies the summarization stability metric, and summarizing the second representation using a summarizer ML model to obtain a summary of the first transcribed text and the second transcribed text.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for incremental streaming for live summaries.

FIG. 2 is a flowchart illustrating example operations of the system of FIG. 1.

FIG. 3 is a block diagram illustrating a more detailed example implementation of the system of FIG. 1.

FIG. 4 is a flowchart illustrating example training techniques for the example of FIG. 3.

FIG. 5 illustrates example inputs and outputs of the systems of FIGS. 1 and 3.

FIG. 6 illustrates example synthesized training data.

FIG. 7 is a third person view of a user in an ambient computing environment.

FIGS. 8A and 8B illustrate front and rear views of an example implementation of a pair of smartglasses.

### DETAILED DESCRIPTION

Described systems and techniques enable, for example, generation of summarized content of spoken speech in ambient conversations, in a reliable, efficient manner. For example, it is possible to capture speech and produce a written transcript, e.g., as live captions. Such live captioning of spoken language, however, may be cognitively overwhelming to users. Described techniques provide a higher-level abstraction or summary of what is being said, in a manner that may be tailored to users' preferences.

In conventional automatic language understanding and summarization systems, transcribed text may be segmented using various external and/or detected triggers, and the segmented text may then be summarized. Such segmentation triggers may include, e.g., a detected pause in the speech, inferred punctuation (e.g., a period, exclamation point, or question mark), or receipt of a manual command (e.g., a verbal command, such as “summarize”)

Such approaches have various shortcomings, including, e.g., excessive latency, inconvenience to the user, loss of continuity, and/or instability of summarized output. For example, latency may be introduced when the system must wait for a pause or the end of a sentence or paragraph. Requiring the user to initiate summaries manually may result in inconvenience to the user, and the user may miss important summaries if the user fails to initiate summarization at an appropriate time. Continuity may be lost when discrete segments are summarized separately/independently. Although it is possible to re-write an earlier summary when a later summary identifies a need for correction, such rewriting is distracting at best to users, and may render the summarizations unusable if the rewriting becomes excessive. The above problems and others make it difficult to apply conventional automatic language understanding and summarization technology in streaming applications to provide a true real-time experience for users.

Described techniques, however, segment and encode incoming text into stable semantic units, which may then be summarized (or otherwise processed) immediately and in response to a determination of stability of the semantic unit(s), without requiring use of any of the various external/detected triggers referenced above. Thus, for example, summarization may be performed in the middle of a sentence, and the resulting summary may be produced immediately and maintained reliably after a remainder of the sentence is summarized. Put another way, the trigger for summarizing does not require detection of a condition/context that is external to the transcribed text or of an internal property of the transcribed text, but rather utilizes a prediction or other determination that a portion of the transcribed text will produce a stable summary that will not be required to be changed when further text is received, even when the further text has not yet been received and is therefore not known.

Consequently, described techniques may be helpful, for example, when a user is deaf or heard of hearing, as the user may be provided with a summary stream visually on a display. Similarly, when the user is attempting to converse with a speaker in a foreign language, the user may be provided with the summary stream in the user's native language. Further, the described techniques allow a user to follow a transcription of speech even when a display only comprises a limited size.

Described techniques may be implemented for virtually any type of spoken input text (text data). For example, automatic speech recognition (ASR), or other transcription techniques, may be used to provide a live transcription of detected speech (audio data), which may then be provided or available to a user as a transcription stream (a data stream). Then, described techniques may be used to simultaneously provide the type of live, stable summarization stream referenced above, i.e., to provide the summarization stream in parallel with the transcription stream.

For example, a user wearing smartglasses or a smartwatch, or using a smartphone, may be provided with either/both a transcription stream and a summarization stream while listening to a speaker. In other examples, a user watching a video or participating in a video conference may be provided with either/both a transcription stream and a summarization stream.

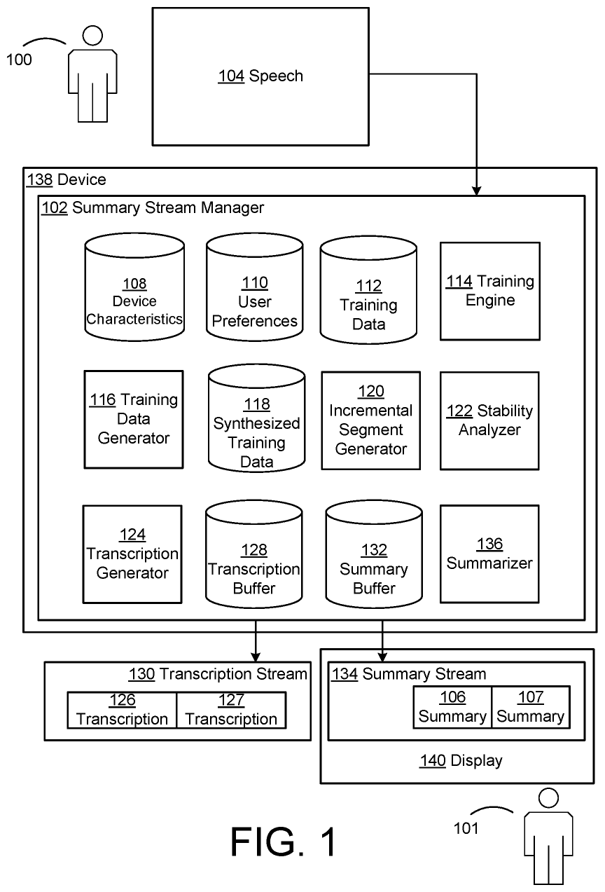

FIG. 1 is a block diagram of a system for incremental streaming for live summaries. In the example of FIG. 1, a summary stream manager 102 processes speech 104 (audio data, also referred to as spoken input) of a speaker 100 to obtain a summary 106 that is provided to a user 101 as part of a live summary stream 134 (a data stream). As referenced above, the speech 104 may include virtually any spoken words or other spoken input. For example, the speech 104 may a lecture, a talk, a dialogue, an interview, a conversation, or any other spoken-word interaction of two or more participants. Such interactions may be largely one-sided (a monologue), such as in the case of a lecture, or may be an equal give-and-take between the speaker 100 and the user 101.

For example, a conversation may be conducted between the speaker 100 and the user 101, and the conversation may be facilitated by the summary stream manager 102. As just noted, in other examples, the speaker 100 may represent a lecturer, while the user 101 represents a lecture attendee, so that the summary stream manager 102 facilitates a utility of the lecture to the user 101. The speaker 100 and the user 101 may be co-located and conducting an in-person conversation, or may be remote from one another and communicating via web conference.

In other examples, the speaker 100 may record the speech 104 at a first time, and the user 101 may view (and receive the summary 106 of) the recorded audio and/or video at a later time. In this sense, the term ‘live conversation’ should be understood to be primarily from the perspective of the user 101. For example, as just noted, the user 101 may listen live to a video of the speaker 100 that was previously recorded, and be provided with the type of live summary stream 134 described herein.

FIG. 1 should thus be understood to illustrate an ability of the summary stream manager 102 to provide the summary 106 in a stand-alone or static manner, in response to a discrete instance of the speech 104 (e.g., summarizing audio of a single recorded video). At the same time, FIG. 1 also illustrates an ability of the summary stream manager 102 to receive speech of the speaker 100 over a first time interval and output the summary 106 to the user 101, and then to repeat such speech-to-summary operations over a second and subsequent time interval(s) to provide a subsequent summary 107, and so on over multiple time intervals to thereby produce the summary stream 134.

As also described in detail, below, the summary stream manager 102 may be implemented in conjunction with any suitable device 138, such as a handheld computing device, smartglasses, earbuds, or smartwatch. For example, the summary stream manager 102 may be implemented in conjunction with one or more such devices in which a microphone or other input device is used to receive the speech 104, and an audio output, visual display (e.g., a display 140 in FIG. 1), and/or other output device(s) is used to render or provide the summary 106 and the summary stream 134.

The summary stream manager 102 is illustrated in the simplified example of FIG. 1 as a single component that includes multiple sub-components. As also described below, however, the summary stream manager 102 may be implemented using multiple devices in communication with one another.

As shown in FIG. 1, the summary stream manager 102 may include or utilize device characteristics 108 of the one or more devices represented by the device 138 in FIG. 1. For example, device characteristics may include a display size of the display 140, available fonts or formats, or available scroll rates of the device 138/display 140.

User preferences 110 (e.g., as determined based on device settings chosen by a user or other operation of the device by a user) may include any user preference for receiving the summary stream 134. For example, the user preferences 110 may include a user preference for a slow, medium, or fast scroll rate of the summary stream 134 on the display 140. The user preferences 110 may also specify preferred fonts/formats, or preferred device(s) among a plurality of available devices. The user preferences 110 may be input manually by the user 101, and/or inferred by the summary stream manager 102 based on actions of the user 101.

Training data 112 generally represents any training data that may be processed by a training engine 114 to train one or more machine learning (ML) models, as described herein. The training data 112 may represent one or more available repositories of labelled training data used to train such ML models, and/or may represent training data compiled by a designer of the summary stream manager 102.

A training data generator 116 may be configured to produce synthesized training data 118, e.g., from the training data 112. The synthesized training data 118 may then be used by the training engine 114 to train an incremental segment generator 120. As referenced above, and described in detail, below, the incremental segment generator 120 may be configured to encode the incoming speech 104 into semantic units. Each semantic unit may be analyzed by a stability analyzer 122 to determine whether the semantic unit is stable with respect to generation of a corresponding summary (e.g., the summary 106) by a summarization ML model, shown as a summarizer 136 in FIG. 1.

In example implementations, the incremental segment generator 120 may be implemented as a sentence splitter model that identifies locations within sentences to include punctuation (e.g., periods, question marks) that help split sentences. In other examples, the incremental segment generator 120 may be implemented as a syntax parser, such as a dependency parser. Syntax parsers analyze the formation of text, by, e.g., identifying parts of speech, such as subject/verb/object relationships, without being required to analyze the meaning of the text. In other implementations, the incremental segment generator 120 may be implemented as a semantic segmentation model, which may be trained and configured to understand the meaning of text in identifying stable segments. Such a semantic segmentation model may be implemented as a language model trained on examples. In other examples, such models may be configured to build semantic graphs that identify actors and relationships in the incoming text; then, once a semantic graph does not exhibit further change, the portion of text used to build the semantic graph may be designated as a semantic unit.

A transcription generator 124 may be configured to convert the spoken words of the speech 104 (audio data) to transcribed text (text data), shown in FIG. 1 as a transcription 126 and a transcription 127. That is, the transcription 126 may be generated in a first time interval (which may correspond to the first time interval over which the summary 106 is provided) and the transcription 127 may be generated in a second, subsequent time interval (which may correspond to the second time interval over which the summary 107 is provided). In example implementations, the transcription generator 124 may include an automatic speech recognition (ASR) engine or a speech-to-text (STT) engine.

The transcription generator 124 may include many different approaches to generating text, including additional processing of the generated text. For example, the transcription generator 124 may provide timestamps for generated text, a confidence level in generated text, and inferred punctuation of the generated text. For example, the transcription generator 124 may also utilize natural language understanding (NLU) and/or natural language processing (NLP) models, or related techniques, to identify semantic information (e.g., sentences or phrases), identify a topic, or otherwise provide metadata for the generated text.

The transcription generator 124 may provide various other types of information in conjunction with transcribed text, perhaps utilizing related hardware/software. For example, the transcription generator 124 may analyze an input audio stream to distinguish between different speakers, or to characterize a duration, pitch, speed, or volume of input audio, or other audio characteristics.

In FIG. 1, the transcription generator 124 may utilize a transcription buffer 128 to output a transcription stream 130. That is, for example, the transcription generator 124 may process a live conversation, discussion, or other speech, in real time and while the speech is happening. The transcription 126 thus represents a transcription of a segment or instance of transcribed text within a time interval that occurs within a larger time period or time window of a conversation.

For example, while the speaker 100 is speaking, the transcription generator 124 may output transcribed text to be stored in the transcription buffer 128. The transcribed text may be designated as intermediate or final text within the transcription buffer 128, before being available as the transcription 126/transcription stream 130. For example, the transcription generator 124 may detect the end of a sentence, a switch in speakers, a pause of pre-defined length, or other detected audio characteristic to designate a final transcription to be included in the transcription stream 130. In other examples, the transcription generator 124 may wait until the end of a defined or detected time interval to designate a final transcription of audio.

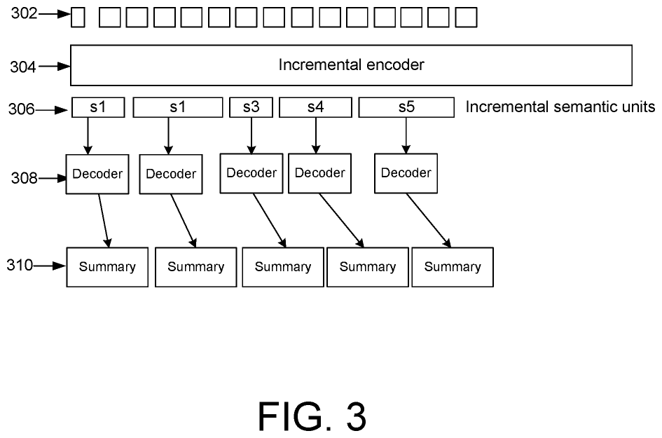

The transcription stream 130 may thus be processed by the incremental segment generator 120, using the stability analyze 122, to provide encoded, stable semantic units, which may then be decoded in a desired manner by the summarizer 136 to populate a summary buffer 132 and otherwise output the summary stream 134. The summarizer 136 may represent any trained model or algorithm designed to perform summarization. For example, the summarizer 136 may be implemented as a sequence-to-sequence generative large learning model (LLM). As described in detail, below, e.g., with respect to FIG. 3, when the incremental segment generator 120 is implemented as an encoder of the types of stable semantic units described herein, the summarizer 136 may be implemented as a decoder that is trained to decode the stable semantic units into, e.g., the summary 106 and the summary 107.

In more detail, the training data 112 may represent available training data that may be used to train, e.g., the summarizer 136 and/or similar summarization models or related models. For example, the training data 112 may include many instances of text, with each instance of text being associated with, or labeled by, a corresponding ground truth summary.

During typical training, for example, a generated summary for a text instance may be compared with the corresponding ground truth summary. When errors occur between the generated summary as compared to the ground truth summary of the training data 112, a type and/or degree of the error may be used by the training engine 114 in a subsequent training iteration to adjust weights or other parameters of, e.g., the summarizer 136. Over multiple iterations, the weights or other parameters may thus be adjusted by the training engine 114 to cause the summarizer 136, once deployed, to process the speech 104 and generate a corresponding compression ratio, with an acceptable level of accuracy.

In conventional training, training data text is pre-segmented, e.g., by sentence or paragraph, and associated with a ground truth summary as described. As noted above, however, it is not always possible or optimal to rely on such segmentations when processing live, real-world speech such as the speech 104.

Consequently, the training data generator 116 may be configured to process the training data 112 to generate synthesized training data 118, which, as noted above, may be used by the training engine 114 to train the incremental segment generator 120 and/or the summarizer 136. For example, the training data generator 116 may truncate text of the training data 112 and associate each instance of resulting truncated text with a corresponding ground truth summary. For example, as described in more detail, below, the training data generator 116 may itself include, or utilize, a pre-trained summarizer that is used to summarize each instance of truncated text. Additionally, or alternatively, the training data generator 116 may be configured to process each instance of truncated text and output, e.g., encode, a corresponding semantic graph.

For example, the training data 112 may include text, “the quick brown fox jumped over the two lazy dogs,” labeled with a summary of “the fox jumped over the dogs.” The training data generator 116 may truncate the text to obtain truncated text instances of “the quick brown fox” and “jumped over the two lazy dogs.” The training data generator 116 may then generate a summary for the first truncated text of “the fox”, and for the second truncated text of “jumped over the dogs.” This simplistic example thus shows that available training data may be expanded so that each sentence (or other defined segment of training data text) and corresponding summary provides at least two instances of truncated text and corresponding summaries, along with the original text segment and ground truth summary.

Then, the training engine 114 may be used to train the incremental segment generator 120, using the synthesized training data 118 and the stability analyzer 122. For example, truncated text instances may be fed incrementally to the incremental segment generator 120, which may then produce corresponding semantic units that may be judged for stability by the stability analyzer 122. These stability judgments may be updated as each new instance of truncated text is processed (e.g., encoded). For example, if a first instance of truncated text has an encoding that is significantly changed once a second instance of truncated text is processed, then the first instance of truncated text may be labeled unstable. Conversely, if the first instance of truncated text has an encoding that is the same or substantially the same even after the second instance of truncated text is processed, then the first instance of truncated text may be labeled stable.

For example, continuing the simple example from above, the first truncated text of “the quick brown fox” may be encoded (in this example, summarized) as “the fox.” In more complex examples, the first truncated text may be encoded as a semantic graph, or other representation. When the second truncated text of “jumped over the two lazy dogs” is processed (e.g., encoded/summarized), the encoding of the first truncated text does not change. Therefore, the first truncated text “the quick brown fox” may be determined to be stable.

In this way, the incremental segment generator 120 may be configured and trained to recognize that text similar to “the quick brown fox” should be considered to be stable, and such text may therefore be summarized upon receipt, even without knowledge of future text that may subsequently be received. For example, once deployed, the transcription generator 124 may generate the transcription 126 from the speech 104 as “the quick black cat.” The incremental segment generator 120 may encode the transcription 126 as a semantic graph, and the stability analyzer 122 may determine that the semantic graph is stable with respect to summarization. That is the resulting semantic graph may be decoded by the summarizer 136 to obtain the summary 106, where the summary 106 is predicted to remain substantially the same irrespective of content of subsequent transcription 127 and/or subsequent summary 107. For example, “the quick black cat” may still be summarized to “the cat,” even if a remainder of the sentence is “ran and hid,” which is very different from the second portion of the original training sentence of “jumped over the two lazy dogs.”

More detailed examples are provided below, e.g., with respect to FIGS. 3-6. In general, however, FIG. 1 illustrates that the summary stream manager 102 may be used to process the speech 104 incrementally, and to trigger summarization operations based on a predicted summary stability of a current increment encoding, without requiring knowledge of content of future (i.e., not yet received) increments. Consequently, the summary stream manager 102 does not require detection of external, internal, or manual summary triggers to initiate summaries, and does not require re-summarizing (e.g., correcting) previous summaries as new transcriptions are received.

In example implementations, the summary stream manager 102 may be configured to manage various other characteristics of the summary stream 134, relative to, or in conjunction with, the transcription stream 130. For example, the summary stream manager 102 may be configured to control various display characteristics with which the transcription stream 130 and/or the summary stream 134 are provided. For example, the stream manager 102 may provide the user 101 with an option to view either or both (e.g., toggle between) the transcription stream 130 and the summary stream 134.

The stream manager 102 may also be configured to display various indicators related to the transcription stream 130 and the summary stream 134. For example, the stream manager 102 may display a summarization indicator that informs the user 101 that a current portion of the summary stream 134 is being generated, while the summarizer 136 is processing a corresponding portion of the transcription stream 130.

Although the transcription buffer 128 and the summary buffer 132 are described herein as memories used to provide short-term storage of, respectively, the transcription stream 130 and the summary stream 134, it will be appreciated that the same or other suitable memory may be used for longer-term storage of some or all of the transcription stream 130 and the summary stream 134. For example, the user 101 may wish to capture a summary of a lecture that the user 101 attends for later review.

In FIG. 1, the transcription stream 130 is shown separately from the summary stream 134, and from the display 140. However, as noted above, the transcription stream 130 may be displayed on the display concurrently with, or instead of, the summary stream 134. Moreover, the transcription stream 130 and the summary stream 134 may be implemented as a single (e.g., interwoven) stream of captions. Put another way, an output stream of the display 140 may alternate between displaying the transcription stream 130 and the summary stream 134.

In the simplified example of the stream manager 102, the various sub-components 108-136 are each illustrated in the singular, but should be understood to represent at least one instance of each sub-component. For example, two or more training engines, represented by the training engine 114, may be used to implement the various types of training described herein. Conversely, two or more modules of FIG. 1 may be implemented as a single module. For example, the incremental segment generator 120 and the stability analyzer 122 may be implemented as a single model or module.

In FIG. 1, the summary stream manager 102 is illustrated as being implemented and executed using a device 138. For example, the device 138 may represent a handheld computing device, such as a smartphone, or a wearable computing device, such as smartglasses, smart earbuds, or a smartwatch.

The device 138 may also represent cloud or network resources in communication with a local device, such as one or more of the devices just referenced. For example, the various types of training data and the training engine 114 may be implemented remotely from the user 101 operating a local device, while a remainder of the illustrated components of the summarization manager are implemented at one or more of the local devices.

The summary 106 and/or the summary stream 134 are illustrated as being output to a display 140. For example, the display 140 may be a display of the device 138, or may represent a display of a separate device(s) that is in communication with the device 138. For example, the device 138 may represent a smartphone, and the display 140 may be a display of the smartphone itself, or of smartglasses or a smartwatch worn by the user 101 and in wireless communication with the device 138.

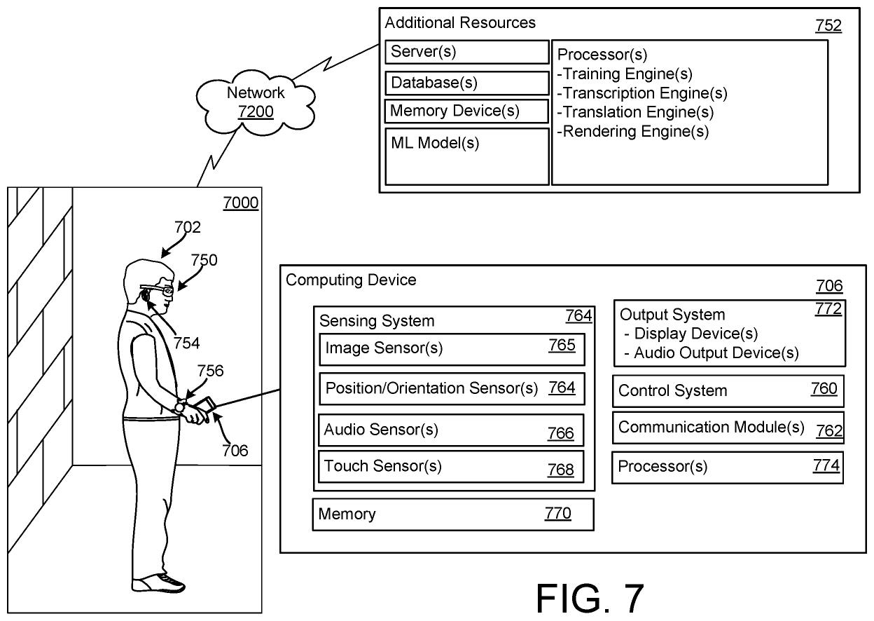

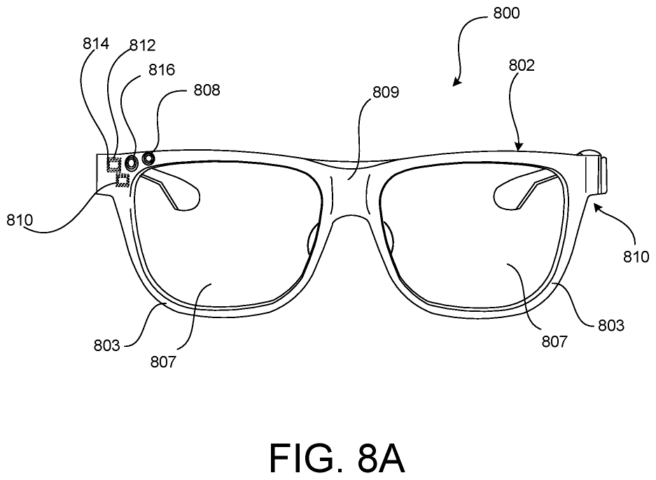

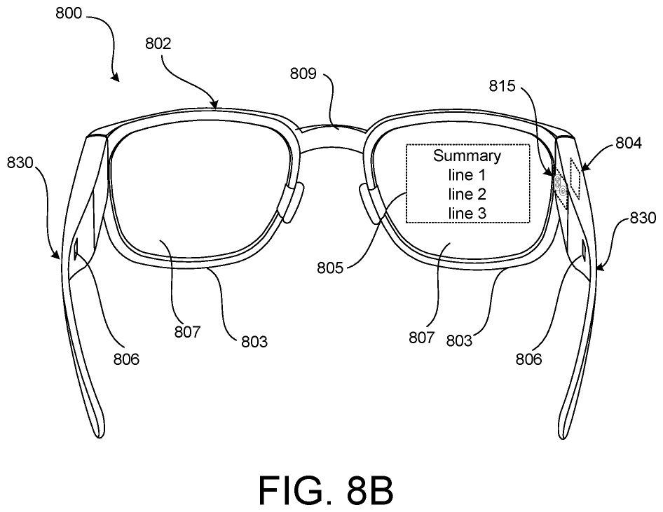

More detailed examples of devices, displays, and network architectures are provided below, e.g., with respect to FIGS. 7, 8A, and 8B. In addition, the summary 106 and the summary 107 of the summary stream 134 (as well as the transcription 126, the transcription 127, and the transcription stream 130) may be output via audio, e.g., using the types of smart earbuds referenced above.

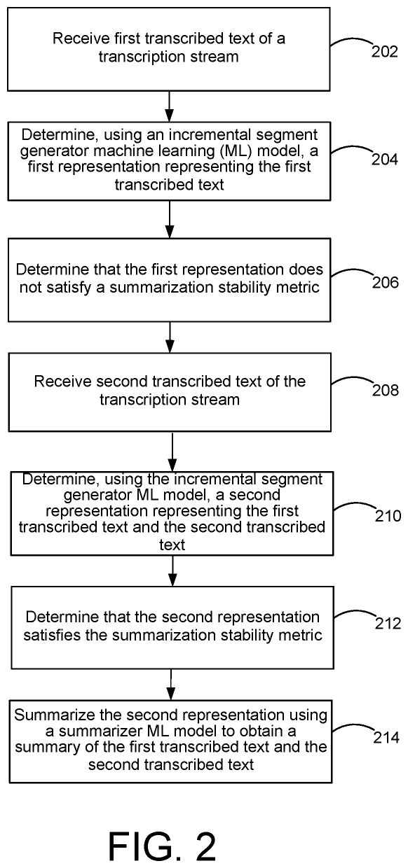

FIG. 2 is a flowchart illustrating example operations of the system of FIG. 1. In the example of FIG. 2, operations 202-214 are illustrated as separate, sequential operations. However, in various example implementations, the operations 202-214 may be implemented in a different order than illustrated, in an overlapping or parallel manner, and/or in a nested, iterative, looped, or branched fashion. Further, various operations or sub-operations may be included, omitted, or substituted. The operations of FIG. 2 may be performed by the system of FIG. 1, in particular by the device 138. Instructions stored in memory of the device 138 may, when executed by the device 138 (e.g., by at least one processor of the device 138), cause the device 138 to perform the operations.

In FIG. 2, first transcribed text of a transcription stream (a data stream comprising text data) is received (202). For example, the incremental segment generator 120 may receive the transcription 126 of the transcription stream 130. For example, similar to the simplified example above, the transcription 126 may include the text “the quick brown fox.”

Using the incremental segment generator 120 machine learning (ML) model, a first representation representing the first transcribed text may be determined (204). For example, as referenced above and described in more detail, below, with respect to FIG. 3, the incremental segment generator 120 may encode the transcription 126 into an encoded output, such as a first semantic graph.

The first representation may be determined not to satisfy a summarization stability metric (206). For example, the stability analyzer 122, which may be separate from, or integrated with, the incremental segment generator 120, may determine that the first representation does not meet a stability threshold or stability score. For example, the stability metric may be defined within some normalized range, such as between 0 and 1, and a stability threshold may be designated within the defined, normalized range. Additional detailed examples of stability metrics are provided below, but, as may be appreciated from the above description, the stability metric represents a prediction or likelihood that a summarization of the first representation will (or will not) change upon receipt of subsequent transcribed text.

In some examples, of course, it may occur that the first representation does satisfy the stability metric. For example, when the transcription 126 includes the text “the quick brown fox,” the incremental segment generator 120 may generate a corresponding encoding, such as a semantic graph, and the stability analyzer 122 may determine that the resulting encoding satisfied the stability metric, whereupon the semantic graph may be decoded by the summarizer 136 to obtain a summary such as “the fox,” even before any subsequent transcribed text is received. For the sake of the example of FIG. 2, however, it is assumed that the first representation (e.g., encoding) does not, by itself, satisfy the stability metric.

Thus, second transcribed text of the transcription stream may be received (208). For example, the transcription 127 may be received, such as, in the above example, “jumped over the two lazy dogs.”

Using the incremental segment generator ML model, a second representation representing the first transcribed text and the second transcribed text may be determined (210). That is, the incremental segment generator 120 may generate the second representation, such as an encoding of a semantic graph, that represents both the first transcribed text (e.g., the transcription 126) and the second transcribed text (e.g., the transcription 127). For example, the incremental segment generator 120 may generate a representation (e.g., encoding) of the entire sentence “the quick brown fox jumped over the two lazy dogs.”

The second representation may then be determined to satisfy the summarization stability metric (212). For example, the stability analyzer 122 may determine that the second representation (e.g., encoding, or semantic graph) may be predicted to be used to generate a summary, e.g., by the summarizer 136, that will not change if/when further transcribed text is received (e.g., subsequent transcriptions within the transcription stream 130).

Accordingly, the second representation may be summarized using the summarizer 136 to obtain a summary, such as the summary 106, of the first transcribed text and the second transcribed text (214). For example, the summarizer may decode an encoding (e.g., semantic graph) of “the quick brown fox jumped over the two lazy dogs,” to obtain a summary such as “the fox jumped over the dogs.”

As noted above, if the first representation determined by the incremental segment generator 120 were determined to satisfy the stability metric, then the transcription 126 might be summarized to obtain the summary 106 (prior to the transcription 127 being received). In such a hypothetical scenario, then the transcription 127 may thereafter also be determined to satisfy the stability metric, whereupon the transcription 127 may be summarized as the summary 107. Thus, FIG. 2 illustrates that the summary stream manager 102 may be configured to incrementally summarize received transcribed text, as soon as the transcribed text is determined to be able to be summarized in a stable fashion, e.g., without requiring changes or updates to summarized text as further transcribed text is received.

FIG. 3 is a block diagram illustrating a more detailed example implementation of the system of FIG. 1. FIG. 3 illustrates that streaming input 302 of transcribed text received at an incremental encoder 304. The incremental encoder 304 provides an example of the incremental segment generator 120 of FIG. 1. In general, encoding operations of the incremental encoder 304, or similar encoder, may be readable yet structured, e.g., a set of topics, key phrases, words, and so on. Encoding may also be unreadable, e.g., a set of numbers organized as vectors, or a matrix understood internally by the encoder model but not by humans.

Incremental semantic units 306 represent stable representations that have been encoded by the incremental encoder 304, using the techniques of FIGS. 1 and 2. Accordingly, each semantic unit of the incremental semantic units 306 may be fed to a decoder 308, which, in the example, represents an example instance of the summarizer 136 of FIG. 1. As a result, summaries 310 may be generated in an incremental manner, in which each of the summaries 310 is generated from a corresponding one of the incremental semantic units 306 independently, and without requiring knowledge of a subsequent incremental unit(s) or corresponding summary/summaries.

Thus, FIG. 3 illustrates techniques for incrementally encoding input (such as spoken language) into granular, stable representations, such as the incremental semantic units 306. In other words, the incremental encoder 304 may be configured to execute an algorithm(s) for incrementally generating a structured semantic representation from streaming text that is stable in that none of the structured representations, or incremental semantic units 306, will change as the result of additional input being received.

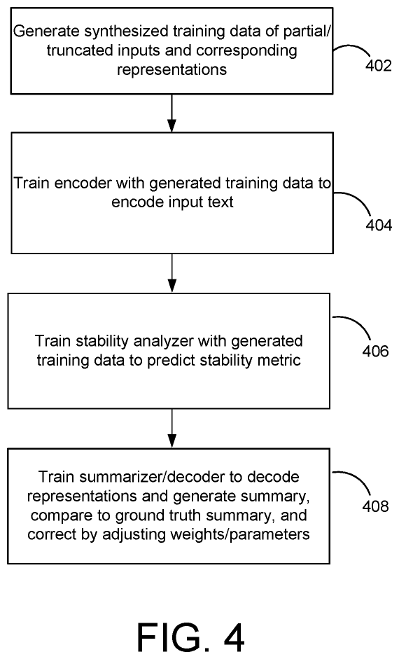

The decoders 308 may then incrementally generate stable abstractions, such as the summaries 310 of FIG. 3. For example, the decoders 308 may be implemented using existing decoders to incrementally generate stable output (such as summaries 310) from intermediate encodings (such as the incremental semantic units 306), where such instances of the decoders 308 may be trained in a manner and to an extent necessary to process the incremental semantic units 306, as referenced above and described in more detail, below, with respect to FIGS. 4-6. Accordingly, the example of FIG. 3 illustrates examples for providing a stable, real-time experience of abstraction (such as summarization) from streaming input 302.

As described above, conventional summarization technology, e.g., for AR glasses, may use an “on-pause”, “on-demand” (manual), or fixed segmentation method(s) to determine when to initiate summarization processing, but such approaches have various disadvantages. For example, on-pause segmentation may require the speaker 100 to artificially insert unnatural, long pauses, which are not practical when using streaming input that the user 101 does not have control over (e.g., when listening to a lecture or announcement). On-demand approaches may result in missing important information, since, e.g., it may not always be obvious how much previous input should be summarized. Other approaches, such as fixed segmentation, as well as detecting topic drift or phonetic changes, or learning segmentations from user behavior, all may be insufficient to provide the type of continual, stable, real-time streaming output that may be desired by the user 101.

In contrast, described incremental semantic encoding may be used to provide stable, real-time, and continuous experiences of live conversations (e.g., in an eyewear form factor), without appreciable lag or latency, and without requiring summaries to be re-processed as additional text is received. Moreover, described solutions provide such stable encoding and decoding that may easily be applied to existing technologies, while decoupling of encoding and decoding operations enables development and use of separate encoding/decoding technologies.

Consequently, described techniques may be applied to a variety of real-time streaming applications, beyond live summarization of spoken language as described herein. For example, described techniques may be used for augmented memory, in which conversations are conveniently and efficiently stored for later retrieval. Techniques may further be used for streaming video applications, including semantic understanding of incoming video and transforming of the incoming video into modalities such as images, video, text, robot actions, and so on, in real-time. Techniques may further be used for real-time communication, including, e.g., sensing focus, affect, and emotion from speech, and communicating results in mixed media such as text, images, emojis, and so on.

Working with intermediate representations such as the incremental semantic units 306 also allows the decoder(s) 308 to match ouput(s) to a bandwidth of a user, such as the user 101. For example, if the user 101 desires only very short bullet point summaries, multiple ones of the incremental semantic units 306 may be combined to produce a single output. On the other hand, if a more granular summary is desired, then the incremental semantic units may be decoded in smaller chunks.

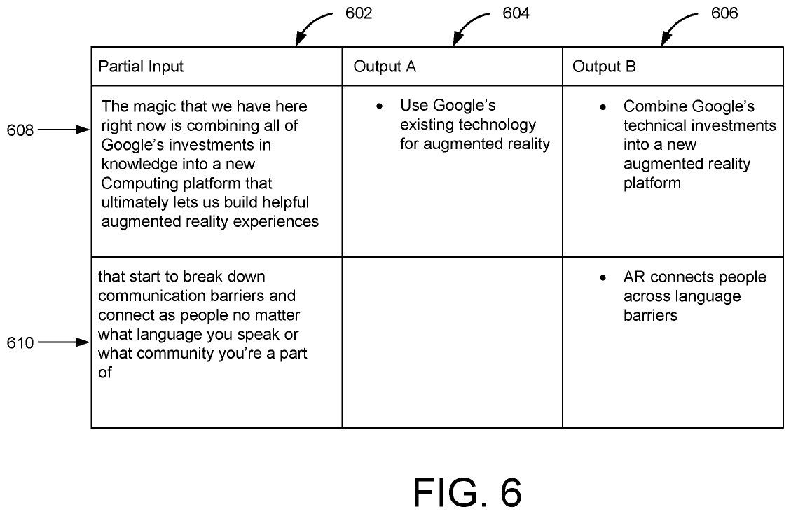

FIG. 4 is a flowchart illustrating example training techniques for the example of FIG. 3, consistent with the example training techniques described with respect to FIG. 1. In the example of FIG. 4, synthesized training data 118 of partial/truncated inputs and corresponding representations is generated (402), e.g., from existing training data 112. In a simplified example of FIG. 6, below, the generated representations may be obtained as bullet point summaries using an existing summarizer model that is trained to produce bullet point summaries, or bullet point summaries may be crowd-sourced for the generated training data.

In other examples, a semantic parser may be used to process the partial inputs and output semantic graphs for inclusion in the synthesized training data. Semantic parsing generally converts sentences into structured semantic representations or logical forms, such as lambda-calculus or an abstract meaning representation (AMR). In some examples, a graph (e.g. AMR) may be used to provide semantic representation of a sentence as a directed acyclic graph, with nodes being concepts (entities/events), and edges being relations. Example implementations of semantic parsing use either parsing and grammars, or neural (seq2seq) models.

Any appropriate encoder may then be trained with the generated training data, including the truncated inputs, to cause the encoder to learn how to process partial inputs in the future (404). During such training, the encoder may receive partial inputs to be encoded, and resulting encoded representations (e.g., bullet points, or semantic graphs) may be compared to ground truth representations. Error correction may then be performed to adjust weights/parameters of the encoder and otherwise complete the training.

The stability analyzer 122 may be trained with the synthesized training data to predict a stability metric(s) for received truncated/partial inputs (406). Different types of stability metrics and stability predictions may be used, depending, for example, on the type of encoder and corresponding representations being used. For example, as described below with respect to FIG. 6, representations as bullet point summaries may use a stability metric based on one or more various types of semantic similarity measures. In other examples, when representations include semantic graphs, stability predictions may be based on observed structures of such graphs, e.g., by predicting stability based on a number and type of nodes and edges in a given semantic graph.

As noted with respect to FIG. 1 and FIG. 3, in some examples, an encoder and corresponding stability analysis/prediction may be provided using a single ML model trained with the synthesized training data. For example, the incremental encoder 304 of FIG. 3 may be trained to determine stability metrics for each of the incremental semantic units 306, as the input text stream 302 is processed by the incremental encoder 304 to generate corresponding representations/encodings.

A summarizer/decoder may be trained to decode representations and generate corresponding summaries, including comparing each generated summary to a corresponding ground truth summary, and correcting/training the model by adjusting weights/parameters accordingly, using appropriate error correction techniques (408). The summarizer/decoder may thus be trained in a manner that reflects an expected (type of) input. For example, when the trained encoder generates textual representations, the summarizer/decoder may be trained to handle textual representations. On the other hand, when the encoder is trained to generate semantic graphs, the summarizer/decoder may be trained to input semantic graphs, as well.

In particular, stable decoding can be achieved by training decoder models, such as the decoder models 308 of FIG. 3, using stable structured data, such as the incremental semantic units 306 of FIG. 3. In other words, training data for the decoders 308 may be determined from existing outputs of a previously implemented encoder.

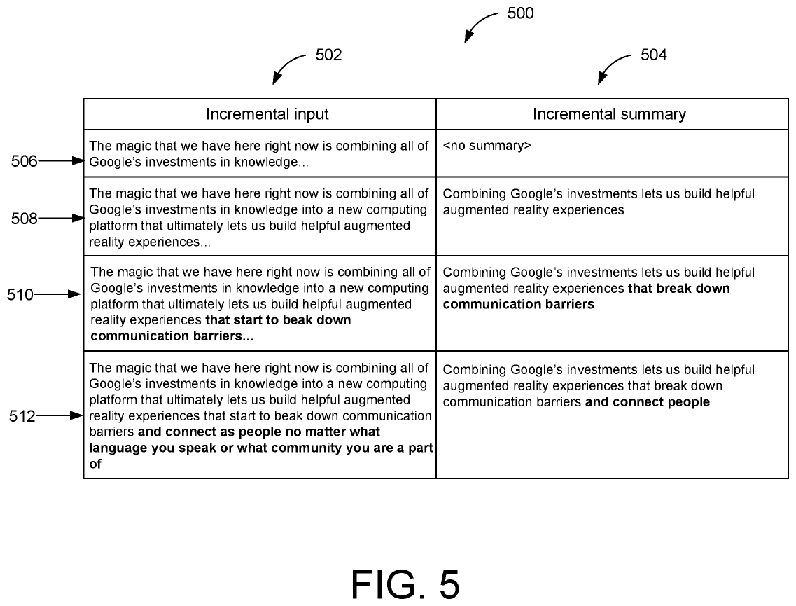

FIG. 5 illustrates example inputs and outputs of the summary stream manager 102 of FIG. 1, or of the system of FIG. 3. In the example of FIG. 5, in table 500, a column 502 illustrates incremental inputs that are summarized using the techniques of FIG. 3 to obtain corresponding incremental summaries in column 504.

In the example of FIG. 5, each row 506, 508, 510, 512 represents consecutive time intervals during which corresponding incremental inputs in the column 502 are received, and for which corresponding incremental summaries in the column 504 are generated. For example, in the row 506 of the column 502, an incremental input of, “The magic that we have here right now is combining all of Google's investments in knowledge . . . ” is received. Consistent with the above discussion of FIGS. 1-3, this incremental input may be encoded into a corresponding first representation (not shown in FIG. 5), and a corresponding stability metric may be determined to indicate that the relevant incremental input is not sufficiently stable to use in generating an incremental summary in row 506 for column 504.

Then, in the row 508 of the column 502, an additional incremental input of, “ . . . into a new computing platform that ultimately lets us build helpful augmented reality experiences . . . ” is received. A second representation (e.g., an incremental semantic unit of FIG. 3, not shown in FIG. 5) may be encoded for the entire incremental input of row 508 and column 502, and a corresponding stability metric may be determined to indicate sufficient stability for generating an incremental summary in row 508 for column 504. Consequently, the corresponding incremental summary of “Combining Google's investments lets us build helpful augmented reality experiences” is generated.

Continuing the example, in the row 510 of the column 502, an additional incremental input of, “ . . . that start to break down communication barriers . . . ” is received. A third representation (e.g., an incremental semantic unit of FIG. 3, not shown in FIG. 5) may be encoded for the entire incremental input of row 510 and column 502, and a corresponding stability metric may be determined to indicate sufficient stability for generating an incremental summary in row 510 for column 504. Consequently, the corresponding incremental summary of “Combining Google's investments lets us build helpful augmented reality experiences that break down communication barriers” is generated.

Finally in FIG. 5, in the row 512 of the column 502, an additional incremental input of, “ . . . and connect as people no matter what language you speak or what community you are a part of . . . ” is received. A fourth representation (e.g., an incremental semantic unit of FIG. 3, not shown in FIG. 5) may be encoded for the entire incremental input of row 512 and column 502, and a corresponding stability metric may be determined to indicate sufficient stability for generating an incremental summary in row 512 for column 504. Consequently, the corresponding incremental summary of “Combining Google's investments lets us build helpful augmented reality experiences that break down communication barriers and connect people” is generated.

FIG. 6 illustrates example synthesized training data, which may be used in the example of FIG. 4, above. As described with respect to FIG. 4, synthesized training data may include partial or truncated inputs, along with corresponding representations. In the simplified example of FIG. 4, further detail is provided for the examples above in which the representations are bullet point summaries.

Specifically, in FIG. 6, a column 602 includes truncated or partial inputs. Column 604 includes a first representation (labeled as ‘output A’), and column 606 includes a second representation (labeled as ‘output B’). In a row 608, a first partial input is received that includes, “The magic that we have here right now is combining all of Google's investments in knowledge into a new computing platform that ultimately lets us build helpful augmented reality experiences . . . ” A first bullet point representation of “Use Google's existing technology for augmented reality” is generated in column 604.

Then, in row 610, column 602 includes a second partial input of “that start to break down communications barriers and connect as people no matter what language you speak or what community you're a part of.” When this second partial input is received, updated representations in the column 606 are generated, including “Combine Google's technical investments into a new augmented reality platform” in row 608 and “AR connects people across language barriers” in row 610.

Then, a stability metric may be used to compare a stability between output A in row 608, column 604 and output B in row 608, column 606. In other words, the stability metric in this example effectively addresses the question of whether these two outputs are meaningfully different than one another, or whether they may be considered sufficiently semantically similar to one another to be considered stable in the presence of the subsequently received partial input of the row 610 in the column 602 (and its corresponding bullet point representation in column 606).

Put another way, the stability analyzer 122 of FIG. 1 may be trained to determine whether the output of “Use Google's existing technology for augmented reality” is sufficiently similar to “Combine Google's technical investments into a new augmented reality platform” to be considered to satisfy a corresponding stability metric. If so, then the partial input of column 602, row 608 may be determined to be stable. Otherwise, the partial input of column 602, row 608 may be determined to be unstable. Then, the process of FIG. 6 may be repeated with a subsequent partial input and corresponding output (not shown in FIG. 6), where the corresponding output may be compared to the generated output of the row 610 and the column 606 to make a similar stability determination.

In the context of such stability determinations, various types of semantic similarity comparisons and algorithms may be used. In general, it may be appreciated that multiple summaries of a single input, by their nature, may convey very similar information using different expressions or different quantities of summarized text. Consequently, stability metrics may be formulated to consider a semantic equivalence between two summaries being compared, rather than, e.g., a verbatim comparison or a measure of sentence similarity. In this way, for example, the stability analyzer 122 of FIG. 1 may be trained as, e.g., a recurrent neural network (RNN) model or other type of causal model, and which may be trained to predict a stability metric in conjunction with each addition of partial input received for encoding.

Thus, FIGS. 1-6 illustrate examples of incremental summarization and other incremental processing, in which outputs are computed before all input is available, allowing the system(s) to act on partial input. Without incremental processing, it may be necessary to wait for each complete utterance, or even a chain of thought, which often leads to substantial latency, especially for tasks requiring higher level understanding, such as summarization.

Described techniques may be used to determine stability, which, in the present context, is analogous to monotonicity. In a non-monotonic system, it is allowed to retract output that was previously produced. In a monotonic or stable system, it is only possible to extend previously generated output(s), and outputs cannot be retracted. In the case of sequential output, monotonicity means only appending of output is allowed. In the case of structured outputs (e.g., parse tree, or semantic graph) stability would imply that only supersets are allowed.

For example, monotonic expansions may be used by extending a connected structure and employing a beam of possible structures. One strategy for such an approach includes the above-described use of truncated inputs in training, which force the model being trained to learn from partial inputs. In other examples, a delayed output approach may be used in which some incoming words are observed before outputting a label, i.e., a lookahead approach. An incremental encoder can be used by limiting attention of a current input to past inputs only, and then recomputing a representation for the previous input when there is a new input.

Various types of models can be employed to implement the above strategies. Recurrent Neural Networks (RNNs) are fundamentally incremental and causal. Standard transformer models are non-causal, but some alternate types of transformer models may be used, such as linear transformers.

In other examples, it may be possible to predict a specific property of an encoded representation from a partial input that determines its stability. For example, if performing a semantic parsing task, a number of edges/nodes in a stable subgraph may be predicted. More generally, the stability of a partial representation may be predicted by, e.g., training an appropriate algorithm using any appropriate underlying model (e.g., a Neural Semantic Parser for a semantic parsing task), and generating representations from partial inputs. Large amounts of training data may thus be synthesized in this way.

FIG. 7 is a third person view of a user 702 (analogous to the user 101 of FIG. 1) in an ambient environment 7000, with one or more external computing systems shown as additional resources 752 that are accessible to the user 702 via a network 7200. FIG. 7 illustrates numerous different wearable devices that are operable by the user 702 on one or more body parts of the user 702, including a first wearable device 750 in the form of glasses worn on the head of the user, a second wearable device 754 in the form of ear buds worn in one or both ears of the user 702, a third wearable device 756 in the form of a watch worn on the wrist of the user, and a computing device 706 held by the user 702. In FIG. 7, the computing device 706 is illustrated as a handheld computing device, but may also be understood to represent any personal computing device, such as a table or personal computer.

In some examples, the first wearable device 750 is in the form of a pair of smart glasses including, for example, a display, one or more images sensors that can capture images of the ambient environment, audio input/output devices, user input capability, computing/processing capability and the like. Additional examples of the first wearable device 750 are provided below, with respect to FIGS. 8A and 8B.

In some examples, the second wearable device 754 is in the form of an ear worn computing device such as headphones, or earbuds, that can include audio input/output capability, an image sensor that can capture images of the ambient environment 7000, computing/processing capability, user input capability and the like. In some examples, the third wearable device 756 is in the form of a smart watch or smart band that includes, for example, a display, an image sensor that can capture images of the ambient environment, audio input/output capability, computing/processing capability, user input capability and the like. In some examples, the handheld computing device 706 can include a display, one or more image sensors that can capture images of the ambient environment, audio input/output capability, computing/processing capability, user input capability, and the like, such as in a smartphone. In some examples, the example wearable devices 750, 754, 756 and the example handheld computing device 706 can communicate with each other and/or with external computing system(s) 752 to exchange information, to receive and transmit input and/or output, and the like. The principles to be described herein may be applied to other types of wearable devices not specifically shown in FIG. 7 or described herein.

The user 702 may choose to use any one or more of the devices 706, 750, 754, or 756, perhaps in conjunction with the external resources 752, to implement any of the implementations described above with respect to FIGS. 1-6C. For example, the user 702 may use an application executing on the device 706 and/or the smartglasses 750 to receive, transcribe, and display the transcription stream 130 of FIG. 1 and/or the summary stream 134 of FIG. 1.

As referenced above, the device 706 may access the additional resources 752 to facilitate the various summarization techniques described herein, or related techniques. In some examples, the additional resources 752 may be partially or completely available locally on the device 706. In some examples, some of the additional resources 752 may be available locally on the device 706, and some of the additional resources 752 may be available to the device 706 via the network 7200. As shown, the additional resources 752 may include, for example, server computer systems, processors, databases, memory storage, and the like. In some examples, the processor(s) may include training engine(s), transcription engine(s), translation engine(s), rendering engine(s), and other such processors. In some examples, the additional resources may include ML model(s), such as the various ML models of the architectures of FIGS. 1 and/or 3.

The device 706 may operate under the control of a control system 760. The device 706 can communicate with one or more external devices, either directly (via wired and/or wireless communication), or via the network 7200. In some examples, the one or more external devices may include various ones of the illustrated wearable computing devices 750, 754, 756, another mobile computing device similar to the device 706, and the like. In some implementations, the device 706 includes a communication module 762 to facilitate external communication. In some implementations, the device 706 includes a sensing system 764 including various sensing system components. The sensing system components may include, for example, one or more image sensors 765, one or more position/orientation sensor(s) 764 (including for example, an inertial measurement unit, an accelerometer, a gyroscope, a magnetometer and other such sensors), one or more audio sensors 766 that can detect audio input, one or more touch input sensors 768 that can detect touch inputs, and other such sensors. The device 706 can include more, or fewer, sensing devices and/or combinations of sensing devices.

Captured still and/or moving images may be displayed by a display device of an output system 772, and/or transmitted externally via a communication module 762 and the network 7200, and/or stored in a memory 770 of the device 706. The device 706 may include one or more processor(s) 774. The processors 774 may include various modules or engines configured to perform various functions. In some examples, the processor(s) 774 may include, e.g., training engine(s), transcription engine(s), translation engine(s), rendering engine(s), and other such processors. The processor(s) 774 may be formed in a substrate configured to execute one or more machine executable instructions or pieces of software, firmware, or a combination thereof. The processor(s) 774 can be semiconductor-based including semiconductor material that can perform digital logic. The memory 770 may include any type of storage device or non-transitory computer-readable storage medium that stores information in a format that can be read and/or executed by the processor(s) 774. The memory 770 may store applications and modules that, when executed by the processor(s) 774, perform certain operations. In some examples, the applications and modules may be stored in an external storage device and loaded into the memory 770.

Although not shown separately in FIG. 7, it will be appreciated that the various resources of the computing device 706 may be implemented in whole or in part within one or more of various wearable devices, including the illustrated smartglasses 750, earbuds 754, and smartwatch 756, which may be in communication with one another to provide the various features and functions described herein. For example, the memory 770 may be used to implement the transcription buffer 128 and the summary buffer 132.

In FIG. 7, any audio and/or video output may be used to provide the types of summaries described herein, and associated features. For example, described techniques may be implemented in any product in which improving speech-to-text would be helpful and in which high-quality summaries would be beneficial. Beyond head-worn displays, wearables, and mobile devices, described techniques may be used in remote conferencing and web apps (including, e.g., providing captions/summaries within webconferencing software and/or pre-recorded videos).

Described techniques may also be useful in conjunction with translation capabilities, e.g., of the additional resources 752. For example, the user 702 may listen to a conversation from a separate speaker (corresponding to the speaker 100 of FIG. 1), who may be proximate to, or removed from, the user 702), where the speaker may be speaking in a first language. A translation engine of the processors of the additional resources 752 may provide automated translation of the dialogue into a native language of the user 702, and also may summarize the translated dialogue using techniques described herein.

The architecture of FIG. 7 may be used to implement or access one or more large language models (LLMs), which may be used to implement a summarizer for use in the preceding examples. For example, the Pathways Language Model (PaLM) and/or the Language Model for Dialogue Application (LaMDA), both provided by Google, Inc., may be used.

An example head mounted wearable device 800 in the form of a pair of smart glasses is shown in FIGS. 8A and 8B, for purposes of discussion and illustration. The example head mounted wearable device 800 includes a frame 802 having rim portions 803 surrounding glass portion, or lenses 807, and arm portions 830 coupled to a respective rim portion 803. In some examples, the lenses 807 may be corrective/prescription lenses. In some examples, the lenses 807 may be glass portions that do not necessarily incorporate corrective/prescription parameters. A bridge portion 809 may connect the rim portions 803 of the frame 802. In the example shown in FIGS. 8A and 8B, the wearable device 800 is in the form of a pair of smart glasses, or augmented reality glasses, simply for purposes of discussion and illustration.

In some examples, the wearable device 800 includes a display device 804 that can output visual content, for example, at an output coupler providing a visual display area 805, so that the visual content is visible to the user. In the example shown in FIGS. 8A and 8B, the display device 804 is provided in one of the two arm portions 830, simply for purposes of discussion and illustration. Display devices 804 may be provided in each of the two arm portions 830 to provide for binocular output of content. In some examples, the display device 804 may be a see through near eye display. In some examples, the display device 804 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 807, next to content (for example, digital images, user interface elements, virtual content, and the like) output by the display device 804. In some implementations, waveguide optics may be used to depict content on the display device 804.

The example wearable device 800, in the form of smart glasses as shown in FIGS. 8A and 8B, includes one or more of an audio output device 806 (such as, for example, one or more speakers), an illumination device 808, a sensing system 810, a control system 812, at least one processor 814, and an outward facing image sensor 816 (for example, a camera). In some examples, the sensing system 810 may include various sensing devices and the control system 812 may include various control system devices including, for example, the at least one processor 814 operably coupled to the components of the control system 812. In some examples, the control system 812 may include a communication module providing for communication and exchange of information between the wearable device 800 and other external devices. In some examples, the head mounted wearable device 800 includes a gaze tracking device 815 to detect and track eye gaze direction and movement. Data captured by the gaze tracking device 815 may be processed to detect and track gaze direction and movement as a user input. In the example shown in FIGS. 8A and 8B, the gaze tracking device 815 is provided in one of two arm portions 830, simply for purposes of discussion and illustration. In the example arrangement shown in FIGS. 8A and 8B, the gaze tracking device 815 is provided in the same arm portion 830 as the display device 804, so that user eye gaze can be tracked not only with respect to objects in the physical environment, but also with respect to the content output for display by the display device 804. In some examples, gaze tracking devices 815 may be provided in each of the two arm portions 830 to provide for gaze tracking of each of the two eyes of the user. In some examples, display devices 804 may be provided in each of the two arm portions 830 to provide for binocular display of visual content.

The wearable device 800 is illustrated as glasses, such as smartglasses, augmented reality (AR) glasses, or virtual reality (VR) glasses. More generally, the wearable device 800 may represent any head-mounted device (HMD), including, e.g., a hat, helmet, or headband. Even more generally, the wearable device 800 and the computing device 706 may represent any wearable device(s), handheld computing device(s), or combinations thereof.

Use of the wearable device 800, and similar wearable or handheld devices such as those shown in FIG. 7, enables useful and convenient use case scenarios of implementations of the systems of FIGS. 1-4. For example, such wearable and handheld devices may be highly portable and therefore available to the user 702 in many different scenarios. At the same time, available display areas of such devices may be limited. For example, the display area 805 of the wearable device 800 may be a relatively small display area, constrained by an overall size and form factor of the wearable device 800.

Consequently, the user 702 may benefit from use of the various summarization techniques described herein. For example, the user 702 may engage in interactions with separate speakers, such as a lecturer or a participant in a conversation. The user 702 and the separate speaker may have varying degrees of interactivity or back-and-forth, and two or more additional speakers may be present, as well.

Using described techniques, the user 702 may be provided with dynamic, real-time summarizations during all such interactions, as the interactions are happening. For example, the speaker may speak for a short time or a longer time, in conjunction with (e.g., in response to) dialogue provided by the user 702. During all such interactions, the user 702 may be provided with useful and convenient summaries of words spoken by the separate speaker(s).

As described, the dynamic, real-time summarizations may be provided with dynamically-updated compression ratios and complexities, or may otherwise be dynamically adjusted over time and during the course of a conversation or other interaction. As a result, the user 101/702 may be provided with meaningful, situation-specific summaries that reduce a cognitive load of the user 101/702 and facilitate meaningful interactions, even when one or more participants in the interaction(s) is not a native speaker, or is currently speaking a different language, or is an expert in a field speaking to a novice in the field.

A first example, referred to herein as example 1, includes a computer program product, the computer program product being tangibly embodied on a non-transitory computer-readable storage medium and comprising instructions that, when executed by at least one computing device, are configured to cause the at least one computing device to:
receive first transcribed text of a transcription stream;
determine, using an incremental segment generator machine learning (ML) model, a first representation representing the first transcribed text;
determine that the first representation does not satisfy a summarization stability metric; receive second transcribed text of the transcription stream;
determine, using the incremental segment generator ML model, a second representation representing the first transcribed text and the second transcribed text;
determine that the second representation satisfies the summarization stability metric; and
summarize the second representation using a summarizer ML model to obtain a summary of the first transcribed text and the second transcribed text.

Example 2 includes the computer program product of example 1, wherein the instructions, when executed by the at least one computing device, are further configured to cause the at least one computing device to:
encode, using the incremental segment generator ML model, the first representation and the second representation as a semantic unit; and
decode the semantic unit using the summarizer ML model to obtain the summary of the first transcribed text and the second transcribed text.

Example 3 includes the computer program product of example 1 or 2, wherein the first representation includes a first semantic graph and the second representation includes a second semantic graph.

Example 4 includes the computer program product of example 3, wherein the stability metric is determined from graph properties of the first semantic graph and the second semantic graph.

Example 5 includes the computer program product of any one of the preceding examples, wherein the stability metric includes a prediction characterizing an extent to which a summary of current transcribed text generated by the summarizer ML model is likely to be changed upon receipt and summarization of subsequent transcribed text.

Example 6 includes the computer program product of any one of the preceding examples, wherein the instructions, when executed by the at least one computing device, are further configured to cause the at least one computing device to:
receive training data that includes input text and a corresponding summary;
truncate the input text to obtain first truncated text and second truncated text;
generate a first encoding of the first truncated text;
generate a second encoding of the first truncated text in conjunction with a third encoding of the second truncated text; and
determine the stability metric based on a comparison of the second encoding and the first encoding.

Example 7 includes the computer program product of example 6, wherein the instructions, when executed by the at least one computing device, are further configured to cause the at least one computing device to:
determine the stability metric based on a similarity of the second encoding and the first encoding.

Example 8 includes the computer program product of example 6 or 7, wherein the instructions, when executed by the at least one computing device, are further configured to cause the at least one computing device to:
train the summarizer ML model using the first encoding, the second encoding, and the third encoding.

Example 9 includes the computer program product of any one of the preceding examples, wherein the instructions, when executed by the at least one computing device, are further configured to cause the at least one computing device to:
display the summary using a head-mounted display (HMD).

Example 10 includes the computer program product of any one of the preceding examples, wherein the instructions, when executed by the at least one computing device, are further configured to cause the at least one computing device to:
generate a summary stream corresponding to the transcription stream and including the summary.

An eleventh example, referred to herein as example 11, includes a device comprising:
at least one display;
at least one processor; and
at least one memory storing instructions, which, when executed by the at least one processor, cause the device to:
   receive first transcribed text of a transcription stream;
   determine, using an incremental segment generator machine learning (ML) model, a first representation representing the first transcribed text;
   determine that the first representation does not satisfy a summarization stability metric;
   receive second transcribed text of the transcription stream;
   determine, using the incremental segment generator ML model, a second representation representing the first transcribed text and the second transcribed text;
   determine that the second representation satisfies the summarization stability metric; and
   summarize the second representation using a summarizer ML model to obtain a summary of the first transcribed text and the second transcribed text.

Example 12 includes the device of example 11, wherein the instructions, when executed by the at least one processor, are further configured to cause the device to:
encode, using the incremental segment generator ML model, the first representation and the second representation as a semantic unit; and
decode the semantic unit using the summarizer ML model to obtain the summary of the first transcribed text and the second transcribed text.

Example 13 includes the device of example 11 or 12, wherein the first representation includes a first semantic graph and the second representation includes a second semantic graph.

Example 14 includes the device of any one of examples 11-13, wherein the stability metric includes a prediction characterizing an extent to which a summary of current transcribed text generated by the summarizer ML model is likely to be changed upon receipt and summarization of subsequent transcribed text.

Example 15 includes the device of any one of examples 11-14, wherein the device includes a head-mounted display (HMD).

Example 16 includes the device of any one of examples 11-15, wherein the instructions, when executed by the at least one processor, are further configured to cause the at least one processor to:
generate a summary stream corresponding to the transcription stream and including the summary.

A seventeenth example, referred to herein as example 17, includes a method comprising:
receiving first transcribed text of a transcription stream;
determining, using an incremental segment generator machine learning (ML) model, a first representation representing the first transcribed text;
determining that the first representation does not satisfy a summarization stability metric;
receiving second transcribed text of the transcription stream;
determining, using the incremental segment generator ML model, a second representation representing the first transcribed text and the second transcribed text;
determining that the second representation satisfies the summarization stability metric; and
summarizing the second representation using a summarizer ML model to obtain a summary of the first transcribed text and the second transcribed text.

Example 18 includes the method of example 17, further comprising:
encoding, using the incremental segment generator ML model, the first representation and the second representation as a semantic unit; and
decoding the semantic unit using the summarizer ML model to obtain the summary of the first transcribed text and the second transcribed text.

Example 19 includes the method of example 17 or 18, further comprising:
receiving training data that includes input text and a corresponding summary;
truncating the input text to obtain first truncated text and second truncated text;
generating a first encoding of the first truncated text;
generating a second encoding of the first truncated text in conjunction with a third encoding of the second truncated text; and
determining the stability metric based on a comparison of the second encoding and the first encoding.

Example 20 includes the method of example 19, further comprising:
training the summarizer ML model using the first encoding, the second encoding, and the third encoding.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as modules, programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor, or LED (light emitting diode)) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

In some implementations, one or more input devices in addition to the computing device (e.g., a mouse, a keyboard) can be rendered in a display of an HMD, such as the HMD 800. The rendered input devices (e.g., the rendered mouse, the rendered keyboard) can be used as rendered in the display.

A number of implementations have been described. Nevertheless, it will be understood that various modifications may be made without departing from the spirit and scope of the description and claims.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user is provided with controls allowing the user to make an election as to both if and when systems, programs, devices, networks, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that user information is removed. For example, a user's identity may be treated so that no user information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Example implementations of the concepts are described herein with reference to cross-sectional illustrations that are schematic illustrations of idealized implementations (and intermediate structures) of example implementations. As such, variations from the shapes of the illustrations as a result, for example, of manufacturing techniques and/or tolerances, are to be expected. Thus, example implementations of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example implementations.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A computer program product, the computer program product being tangibly embodied on a non-transitory computer-readable storage medium and comprising instructions that, when executed by at least one computing device, are configured to cause the at least one computing device to:
receive first transcribed text of a transcription stream;
determine, using an incremental segment generator machine learning (ML) model, a first representation representing the first transcribed text;
determine that the first representation does not satisfy a summarization stability metric;
receive second transcribed text of the transcription stream;
determine, using the incremental segment generator ML model, a second representation representing the first transcribed text and the second transcribed text;
determine that the second representation satisfies the summarization stability metric; and
summarize the second representation using a summarizer ML model to obtain a summary of the first transcribed text and the second transcribed text.

2. The computer program product of claim 1, wherein the instructions, when executed by the at least one computing device, are further configured to cause the at least one computing device to:
encode, using the incremental segment generator ML model, the first representation and the second representation as a semantic unit; and
decode the semantic unit using the summarizer ML model to obtain the summary of the first transcribed text and the second transcribed text.

3. The computer program product of claim 1, wherein the first representation includes a first semantic graph and the second representation includes a second semantic graph.

4. The computer program product of claim 3, wherein the stability metric is determined from graph properties of the first semantic graph and the second semantic graph.

5. The computer program product of claim 1, wherein the stability metric includes a prediction characterizing an extent to which a summary of current transcribed text generated by the summarizer ML model is likely to be changed upon receipt and summarization of subsequent transcribed text.

6. The computer program product of claim 1, wherein the instructions, when executed by the at least one computing device, are further configured to cause the at least one computing device to:
receive training data that includes input text and a corresponding summary;
truncate the input text to obtain first truncated text and second truncated text;
generate a first encoding of the first truncated text;
generate a second encoding of the first truncated text in conjunction with a third encoding of the second truncated text; and
determine the stability metric based on a comparison of the second encoding and the first encoding.

7. The computer program product of claim 6, wherein the instructions, when executed by the at least one computing device, are further configured to cause the at least one computing device to:
determine the stability metric based on a similarity of the second encoding and the first encoding.

8. The computer program product of claim 6, wherein the instructions, when executed by the at least one computing device, are further configured to cause the at least one computing device to:
train the summarizer ML model using the first encoding, the second encoding, and the third encoding.

9. The computer program product of claim 1, wherein the instructions, when executed by the at least one computing device, are further configured to cause the at least one computing device to:
display the summary using a head-mounted display (HMD).

10. The computer program product of claim 1, wherein the instructions, when executed by the at least one computing device, are further configured to cause the at least one computing device to:
generate a summary stream corresponding to the transcription stream and including the summary.

11. A device comprising:
at least one display;
at least one processor; and
at least one memory storing instructions, which, when executed by the at least one processor, cause the device to:
receive first transcribed text of a transcription stream;
determine, using an incremental segment generator machine learning (ML) model, a first representation representing the first transcribed text;
determine that the first representation does not satisfy a summarization stability metric;
receive second transcribed text of the transcription stream;
determine, using the incremental segment generator ML model, a second representation representing the first transcribed text and the second transcribed text;
determine that the second representation satisfies the summarization stability metric; and
summarize the second representation using a summarizer ML model to obtain a summary of the first transcribed text and the second transcribed text.

12. The device of claim 11, wherein the instructions, when executed by the at least one processor, are further configured to cause the device to:
encode, using the incremental segment generator ML model, the first representation and the second representation as a semantic unit; and
decode the semantic unit using the summarizer ML model to obtain the summary of the first transcribed text and the second transcribed text.

13. The device of claim 11, wherein the first representation includes a first semantic graph and the second representation includes a second semantic graph.

14. The device of claim 11, wherein the stability metric includes a prediction characterizing an extent to which a summary of current transcribed text generated by the summarizer ML model is likely to be changed upon receipt and summarization of subsequent transcribed text.

15. The device of claim 11, wherein the device includes a head-mounted display (HMD).

16. The device of claim 11, wherein the instructions, when executed by the at least one processor, are further configured to cause the at least one processor to:
generate a summary stream corresponding to the transcription stream and including the summary.

17. A method comprising:
receiving first transcribed text of a transcription stream;
determining, using an incremental segment generator machine learning (ML) model, a first representation representing the first transcribed text;
determining that the first representation does not satisfy a summarization stability metric;
receiving second transcribed text of the transcription stream;
determining, using the incremental segment generator ML model, a second representation representing the first transcribed text and the second transcribed text;
determining that the second representation satisfies the summarization stability metric; and
summarizing the second representation using a summarizer ML model to obtain a summary of the first transcribed text and the second transcribed text.

18. The method of claim 17, further comprising:
encoding, using the incremental segment generator ML model, the first representation and the second representation as a semantic unit; and
decoding the semantic unit using the summarizer ML model to obtain the summary of the first transcribed text and the second transcribed text.

19. The method of claim 17, further comprising:
receiving training data that includes input text and a corresponding summary;
truncating the input text to obtain first truncated text and second truncated text;
generating a first encoding of the first truncated text;
generating a second encoding of the first truncated text in conjunction with a third encoding of the second truncated text; and
determining the stability metric based on a comparison of the second encoding and the first encoding.

20. The method of claim 19, further comprising:
training the summarizer ML model using the first encoding, the second encoding, and the third encoding.
